(19) United States
(12) Patent Application Publication
(10) Pub. No.: US 2026/0089231 A1
(43) Pub. Date: Mar. 26, 2026

(54) SYSTEM AND METHOD FOR PRESENTING TIME-RELEVANT CONTENT ITEMS TO A USER

(71) Applicants: Gyanveer Singh, Bengaluru (IN); Bharat Verma, Bengaluru (IN)

(72) Inventors: Gyanveer Singh, Bengaluru (IN); Bharat Verma, Bengaluru (IN)

(21) Appl. No.: 18/892,348

(22) Filed: Sep. 21, 2024

(51) Int. Cl. H04L 67/55

(52) U.S. Cl. CPC H04L 67/55

(57) ABSTRACT

The present disclosure discloses a system and method for presenting time-relevant content items to a user. The system may receive content items from one or more content sources on a user device, pre-process the received content items by converting each of the received content items into a machine-readable format, and analyze the content items, converted in the machine-readable format, to identify contextual meaning and time relevancy of each of the one or more content items by employing Machine Learning (ML) models. The system may mark each of the content items as time-relevant and time-irrelevant based on the identified corresponding contextual meaning and time relevancy. The system may present the content items to the user with corresponding time-relevant or time-irrelevant tags based on the marking.

### CROSS-REFERENCE TO RELATED APPLICATION

This application is based upon and claims priority from, Application No. IN 202341063931, filed on 22 Sep. 2023 titled “RENDERING TIME RELEVANT CONTENT TO A USER” the entireties of which is incorporated herein by reference for all purposes.

### BACKGROUND

### Technical Field

The present disclosure relates to the field of digital communication, and particularly relates to, a system and method for presenting time-relevant content items to a user.

### Description of the Related Art

In today's digital ecosystem, users are overwhelmed with a continuous stream of content from diverse sources, including social media platforms, messaging services, and email systems. This influx of information, referred hereto also as content items, is presented to users in a variety of formats such as notifications, social media posts, text messages, emails, audio recordings, videos, and images. Managing and prioritizing these content items presents significant challenges, particularly in ensuring that users engage with information that is both relevant and timely.

In many scenarios, users face the dilemma of either clearing all notifications without reviewing them, which risks overlooking important messages buried among numerous notifications, or manually reviewing each content items that may take a long time. The existing ways of presenting and consuming these content items are inefficient and ineffective. For instance, a notification indicating an event scheduled for 1 Mar. 2023, which is viewed on 3 Mar. 2023, may no longer be relevant to the user. Such temporal misalignment underscores the difficulty users encounter in distinguishing content that retains its significance from that which has lost its relevance.

Traditional content management systems primarily focus on categorizing and organizing content based on static criteria such as content type or subject matter. For example, some systems employ keyword-based or rule-based algorithms to filter and sort content. While these approaches can help in managing large volumes of data, they often lack the capability to address the dynamic nature of content relevance, particularly in relation to time-sensitive factors.

Prior art in the field partially addresses these challenges by organizing messages and social media posts based on contextual similarities. Systems such as Gmail utilize auto-categorization to group emails into categories like work-related, ecommerce-related, and others. However, these existing systems predominantly focus on contextual grouping rather than addressing the temporal relevance of content. Consequently, while these systems may effectively cluster content based on subject matter, they do not adequately consider the time-sensitivity of the information, which is crucial for effective content management.

Moreover, existing methods often lack the capability to adapt to real-time changes in content relevance. For example, a notification system that does not consider the passage of time or the evolving context of user interactions may present outdated or irrelevant information.

Thus, there is a need for a system and method for identifying and presenting time-relevant content items to the user to overcome the above-mentioned drawbacks.

### BRIEF SUMMARY

The present disclosure discloses a system and method for presenting time-relevant content items to a user. The system facilitates the user to efficiently and effectively keep-up with received content items, such as messages, notifications, advertising prompts, and social media posts. Further, the system may read each of the content items accessible to the user and mark or tag it as either time-relevant or time irrelevant and present to the user. In an embodiment, the system may present only time-relevant content items to the user. Based on tagging of content items as either time relevant or time irrelevant, the user may quickly skip all time irrelevant messages content items. For instance, when a user is catching up on unread messages on a particular day, the messages that are irrelevant on that day may be tagged as ‘time-irrelevant’ or in red color and the messages that are relevant on that day may be tagged as ‘time-relevant’ or in green color. Such an approach may facilitate the users to prioritize their attention to currently relevant content, resulting in an enhanced user experience by ensuring that the content they engage with is timely and valuable. In an embodiment, such tags may be dynamically and automatically updated and rendered to the user. In another embodiment, the user may have an option to see messages with such tags or just see messages that are time-relevant at that particular point of time.

One or more embodiments are directed to a system and method for presenting time-relevant content items to a user. The system includes a receiver module to receive content items on a user device. The content items include system notifications, application notifications, emails, text messages, Short Message Service (SMS), image messages, video messages, audio messages, and social media alerts. Further, the content items are received from one or more digital platforms including pre-installed applications, third-party applications, and system applications.

In an embodiment, the system notifications may include, but not limited to, alerts, such as warnings related to device status, software updates, power alerts, connectivity alerts, storage alerts, maintenance reminders, critical updates, etc.

In an embodiment, the system includes a pre-processing module to pre-process the received content items by converting each of the received content items into a machine-readable format. In an embodiment, the pre-processing module includes a speech-to-text engine, a Natural Language Processor (NLP), and an image-to-text engine to convert the content items into a standard machine-readable format.

In an embodiment, the system includes an analyzer module to analyze the content items, in the machine-readable format, to identify contextual meaning and time relevancy of each of the content items. The analyzer module may use a Machine Learning (ML) model that is trained to determine time relevancy and time irrelevancy of different content items based on associated semantics. The ML model may use any or combination of a regression model, a self-learning model, a self-adapting model, and a self-improving model, to determine time-relevancy of each of the content items. The analyzer module may determine the time relevancy of each content items based on timestamp of each received content items, semantic of each content items, contextual correlation of each of the content items with associated preceding or subsequent content items of similar type, publicly available data, and personal data of the user.

In an embodiment, the analyzer module analyzes the content items, in the machine-readable format, to mark each of the content items as time-relevant or time-irrelevant based on the identified corresponding semantic meaning and time relevancy.

In an embodiment, the system includes a presenting module to present the content items to the user with corresponding time-relevant or time-irrelevant tags based on the marking. Further, the presenting module provides the user with an option to view each of the content items with time-relevant and time-irrelevant tags, or only the content items marked as time-relevant.

In an embodiment, the system includes a filtering module to filter out the content items marked as time-irrelevant, such that only time-relevant content items are presented to the user.

In an embodiment, the system may include a ranking module to rank the filtered time-relevant content items, based on urgency associated with the one or more content, time-sensitivity decay rate, user historical engagement levels with related time-relevant content, and/or proximity of the time-relevant content to a scheduled event, such that the ranked filtered time-relevant content items are presented to the user.

In an embodiment, the method includes receiving content items on a user device, pre-processing the received content items by converting each of the received content items into a machine-readable format, analyzing the content items converted in the machine-readable format to identify contextual relevancy and time relevancy of each of the content items, and marking each content items as either time relevant or time irrelevant. In the embodiment, the method may include steps of marking each of the content items as either contextually relevant or contextually irrelevant. In an embodiment, the method includes steps of presenting the content items to the user with corresponding time-relevant and time-irrelevant tags based on the marking.

### BRIEF DESCRIPTION OF DRAWINGS

The present subject matter will now be described in detail with reference to the drawings, which are provided as illustrative examples of the subject matter to enable those skilled in the art to practice the subject matter. It will be noted that throughout the appended drawings, features are identified by reference numerals. Notably, the FIGUREs and examples are not meant to limit the scope of the present subject matter to a single embodiment, but other embodiments are possible by way of interchange of some or all the described or illustrated elements and, further, wherein:

FIG. 1 illustrates an exemplary environment having a system for presenting time-relevant content to a user, in accordance with an embodiment of the present disclosure;

FIG. 2 illustrates a block diagram of the system for presenting time-relevant content items to the user, in accordance with an embodiment of the present disclosure;

FIG. 3A illustrates an exemplary user interface displaying messages received at various time instances in a messaging group on the user device that is further presented in an optimized matter in accordance with an embodiment of the present disclosure;

FIG. 3B illustrates an exemplary user interface displaying messages prioritized based on time relevancy, in accordance with an embodiment of the present disclosure;

FIG. 3C illustrates an exemplary interface displaying relevancy adjustment of time-relevant message, in accordance with an embodiment of the present disclosure;

FIG. 4 illustrates an exemplary user interface of the user device displaying messages marked based on time relevancy, in accordance with an embodiment of the present disclosure;

FIG. 5A illustrates a user interface displaying various notifications received at different time instances that are presented in an optimized manner on the user device in accordance with an embodiment of the present disclosure;

FIG. 5B illustrates a user interface displaying only the notifications with time-relevant tag, on the user device in accordance with an embodiment of the present disclosure;

FIG. 6 illustrates a timing diagram for presenting time-relevant content items to the user, in accordance with an embodiment of the present disclosure;

FIG. 7 illustrates an exemplary flowchart for a method for presenting time-relevant content to a user, in accordance with an embodiment of the present disclosure; and

FIG. 8 illustrates an exemplary computer unit in which or with which embodiments of the present invention may be utilized.

Other features of embodiments of the present disclosure will be apparent from accompanying drawings and detailed description that follows.

### DETAILED DESCRIPTION

The detailed description set forth below in connection with the appended drawings is intended as a description of exemplary embodiments in which the presently disclosed process can be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed method and system. However, it will be apparent to those skilled in the art that the presently disclosed process may be practiced without these specific details. In some instances, well-known structures and devices are shown in block diagram form in order to avoid obscuring the concepts of the presently disclosed method and system.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and human operators.

Embodiments of the present invention may be provided as a computer program product, which may include a machine-readable storage medium tangibly embodying thereon instructions, which may be used to program the computer (or other electronic devices) to perform a process. The machine-readable medium may include, but is not limited to, fixed (hard) drives, semiconductor memories, such as ROMs, PROMs, random access memories (RAMs), programmable read-only memories (PROMs), erasable PROMs (EPROMs), electrically erasable PROMs (EEPROMs), flash memory or other types of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within the single computer) and storage systems containing or having network access to a computer program(s) coded in accordance with various methods described herein, and the method steps of the invention could be accomplished by modules, routines, subroutines, or subparts of a computer program product.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed therebetween, while not sharing any physical connection with one another. Based on the disclosure provided herein, one of ordinary skill in the art will appreciate a variety of ways in which connection or coupling exists in accordance with the aforementioned definition.

If the specification states a component or feature “may,” “can,” “could,” or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

It will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular name.

The present disclosure discloses a system and method for presenting time-relevant content items to a user. The system may receive content items from one or more content sources on a user device, pre-process the received content items by converting each of the received content items into a machine-readable format and analyze the content items, converted in the machine-readable format, to identify contextual meaning and time relevancy of of each of the one or more content items by employing Machine Learning (ML) models. The system may mark each of the content items as time-relevant and time-irrelevant based on the identified corresponding contextual meaning and time relevancy. The system may present the content items to the user with corresponding time-relevant or time-irrelevant tags based on the marking.

The system may analyze the content items, in the machine-readable format, to identify contextual meaning and time relevancy of each of the content items. The system may use a Machine Learning (ML) model that is trained to determine time relevancy and time irrelevancy of different content items based on its semantic. The ML model may use any or combination of a regression model, a self-learning model, a self-adapting model, and a self-improving model, to determine time-relevancy of each of the content items. The system may determine time relevancy of each content items based on timestamp of each received content items, semantic of each content items, contextual correlation of each of the content items with its preceding or subsequent content items of similar type, publicly available data, and personal data of the user.

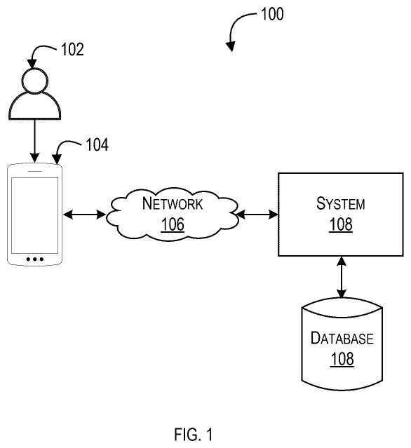

FIG. 1 illustrates an exemplary environment 100 having a system 108 for presenting time-relevant content to a user 102, in accordance with an embodiment of the present disclosure. In an embodiment, the system may include the user 102, a user device 104, a network 106, the system 108, and a database 110. The environment 100 may be an office setting, a home, a public space, or a mobile scenario, where the user 102 may access content items through the user device 104. The content items may include various forms of digital information and media that the user 102 may interact via the user device 104. In some embodiments, the content item may include, but is not limited to, emails, text messages, system alerts, application generated notifications, multimedia content such as images and videos, and other digital data.

In an embodiment, the user device 104 may include, but is not limited to, mobile devices, personal computers, wearable devices, or other connected devices capable of receiving content through a network 106. Further, the user device 104 may include hardware components like a processor, memory, input/output interfaces, and communication components that may facilitate a communication with the system 108 via the network 106. Moreover, the user device 104 may also display and/or present, via a user interface, content item to the user 102.

In an embodiment, the network 106 may facilitate a connection between the user device 104, the system 108, and the database 110. Further, the network 106 may include a combination of wireless and wired communication protocols, such as Wi-Fi, cellular networks, Ethernet, or any other suitable communication channel. Furthermore, the network 106 may facilitate the transfer of data between the user device 104, the system 108, and the database 110.

In an embodiment, the system 108 may receive the content items from the user device 104 and evaluate the content items relevancy based on the current time context. Further, the system may assess factors such as time relevancy and significance of each piece of content in relation to ongoing activities or needs of the user 102. The system 108 may determine the content item that may be relevant and/or pertinent at current moment of time. Further, the system 108 may categorize, highlight, and/or tag the content items accordingly based on relevancy and time-sensitiveness. The tagging based on the relevancy and time-sensitiveness may facilitate the user 102 in organizing and prioritizing information of the content item. In an embodiment, the system 108 may present the sorted and tagged content to the user 102 via the user device 104. Further, the system 108 may prioritize displaying and/or presenting the tagged time-relevant content item to the user 102 to ensure that the user 102 may quickly focus on time-relevant content items.

In an embodiment, the database 110 may be a structured or unstructured data storage solution, such as a relational database, NoSQL database, or any suitable data storage technology. The system 108 may access the database 110 through the network 106 to fetch necessary data for processing and presenting content items to the user 102.

In an embodiment, the database 110 may include metadata related to content items, such as timestamps, sender details, and content type, that may help in assessing the context and relevance of the content items. Further, the database 110 may include user 102 profile with details about user preferences, historical interactions, and personalized settings to tailor the content evaluation and presentation. Furthermore, the database 110 may include contextual data, such as calendar events or location information, to facilitate determining the time relevancy and significance of content items. Moreover, the database 110 may include historical data on past content interactions and user engagement metrics to refine content relevance assessments. Additionally, the database 110 may store system configuration data, detailing settings and operational parameters necessary for processing and presenting content item.

In an embodiment, the system 108 and the database 110 may be cloud-based and hosted on remote servers, accessible over the internet. In another embodiment, the system 108 and the database 110 may be in the user device 104. In another embodiment, the system 108 and the database 110 may be hybrid, where portions of the system 108 and the database 110 may be distributed between the user device 104 and remote servers.

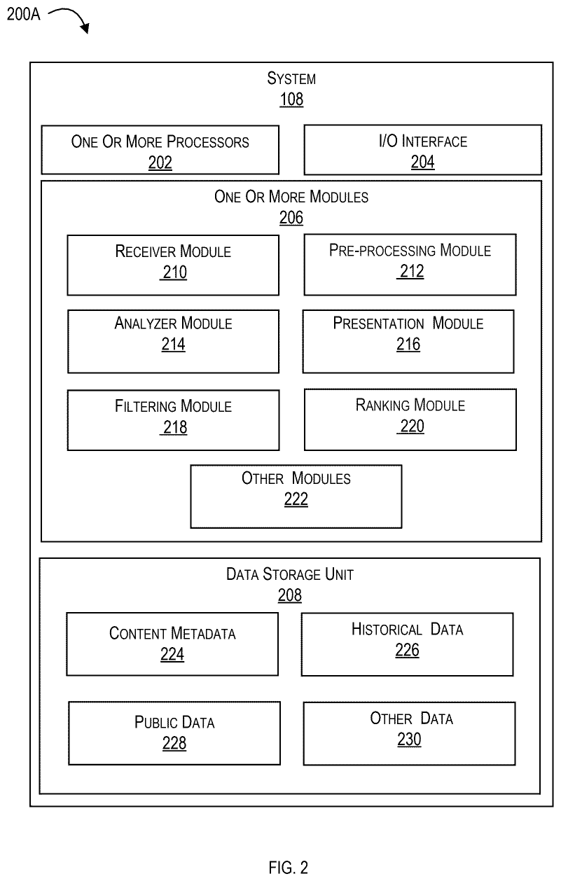

FIG. 2 illustrates a block diagram 200 of the system 108 for presenting time-relevant content items to the user 102, in accordance with an embodiment of the present disclosure. In an embodiment, the system 108 may include one or more processors 202, an Input/Output (I/O) interface 204, one or more modules 206 (may also be termed as one or more engines), and a data storage unit 208. The one or more processors 202 may be implemented as one or more microprocessors, microcomputers, digital signal processors, central processing units, state machines, logic circuitries, and/or any devices that manipulate data or signals based on operational instructions. Further, the I/O interface 204 may serve as the pivotal bridge connecting the internal processes of the system 108 with its external environment for facilitating the exchange of information between the system 108 and the user 102 or external devices. Furthermore, the I/O interface 204 may contribute to the user 102 experience by providing intuitive means for input, such as through keyboards or touchscreens, and presenting meaningful output via displays or other output devices.

In an embodiment of the present disclosure, the one or more processors 202 and the data storage unit 208 may form a part of a chipset installed in the system 108. In another embodiment of the present disclosure, the data storage unit 208 may be implemented as a static memory or a dynamic memory. In an example, the data storage unit 208 may be internal to the system 108. In another example, the data storage unit 208 may be external to the system 108, such as cloud-based storage. The one or more module 206 may be communicatively coupled to the data storage unit 208 and the one or more processor 202 of the system 108. The one or more processors 202 may be configured to control and execute the operations of the one or more modules 206.

In some non-limiting embodiments or aspects, the data storage unit 208 may be communicatively coupled to the one or more processors 202 and/or the one or more modules 206. In an embodiment, the data storage unit 208 may store instructions, executable by the one or more processors 202, which on execution, may cause the system 108 to present time-relevant content items to the user 102. In some non-limiting embodiments or aspects, the data storage unit 208 may store sensitive data of the user 102. The personal data of the user 102 may be utilized for personalizing the system 108 to learn the specific patterns, terminologies, and context associated with the user engagement and/or behavior. In an embodiment, the data storage unit 208 may include content metadata 224, user interaction history data 226 (also termed as historical data 226), public data 228, and other data 230

In a non-limiting embodiment, the system 108 may be implemented on a server, such as a cloud-based server, that may be communicatively coupled to each user device 104. In some non-limiting embodiments or aspects, the system 108 may be implemented in each of the user devices 104, such as a laptop computer, a desktop computer, a Personal Computer (PC), a notebook, a smartphone, and a tablet.

In one implementation, the one or more modules 206 may include, but is not limited to, a receiver module 210, a pre-processing module 212, an analyzer module 214, a presentation module 216, a filtering module 218, a ranking module 220 and, other modules 222 associated with the system 108. The receiver module 210, the pre-processing module 212, the analyzer module 214, the presentation module 216, the filtering module 218, the ranking module 220 and the other modules 222 may be communicatively coupled to a memory and a processor of the system 108.

In an embodiment, the receiver module 210 may receive one or more content items on the user device 104. The one or more content items may be received from one or more digital platforms. Further, the one or more content items may include system notifications, application generated notifications or alters, emails, text messages, Short Message Service (SMS), image messages, video messages, audio messages, and social media alerts. Furthermore, the one or more content items may be associated with traditional messages, Multi-Media Services (MMS), social media posts, social media feeds, interaction communication messages, application generated alerts, advertising prompts, or the any other notification or message from social media/communication service.

In an embodiment, the system notifications may include, but are not limited to, alerts, such as warnings related to device status, software updates, power alerts, connectivity alerts, storage alerts, maintenance reminder, critical updates, etc.

In an embodiment, the one or more digital platforms may include pre-installed applications, third-party applications, and system applications. The pre-installed applications may be the software/applications that may come pre-loaded on the user device 104. The software/applications may include essential tools such as messaging apps, email clients, and calendar applications, facilitating basic communication and organizational functions. For example, a smartphone may come with a built-in email client that enables users to access associated email accounts without the need to download additional software. The receiver module 210 may directly integrate with the pre-installed applications to receive content items such as system notifications, emails, and event reminders, ensuring that user 102 remains updated on important information from the outset.

In an embodiment, the third-party applications may include applications developed by external developers and made available for download through app stores or other distribution channels. The third-party applications may offer specialized functions to extend the capabilities of the user device 104. For instance, the user 102 may download a third-party social media application that provides access to various platforms for communication and sharing. The receiver module 210 may interact with the third-party applications to receive content items such as social media notifications, direct messages, or alerts about user interactions.

In an embodiment, the system applications may include software components that may be integral to the operating system of the user device 104. The system applications may include functionalities such as system settings, file management tools, and device management utilities. Further, the system applications may support various user functionalities by offering alerts and reminders related to scheduled events, tasks, or deadlines. For instance, a calendar system application may generate reminders for upcoming appointments or deadlines. The receiver module 210 may interact with the system applications to receive content items, such as notifications, reminders, direct messages, or alerts.

In an embodiment, the pre-processing module 212 may include pre-processing the received one or more content items by converting each of the received one or more content items into a machine-readable format. The pre-processing module 212 may include a speech-to-text engine, a Natural Language Processor (NLP), and an image-to-text engine.

The speech-to-text engine may convert the received audio messages into text. Further, speech-to-text engine may convert the speech into exact text with low accuracy due to reasons such as, but not limited to, accents. For example, if a user says, ‘my name is Bert’, then the speech-to-text engine may hear it as ‘my name is bird’. Further the natural languages Processor (NLP) processes may convert text by the speech-to-text engine into text messages. For example, the NLP may process ‘my name is bird’ to make sense and may output ‘my name is Bert’. Furthermore, the image-to-text engine may convert the received image messages/video messages into text messages.

In an embodiment, the analyzer module 214 may analyze the one or more content items, in the machine-readable format, to identify contextual meaning and time relevancy of each of the one or more content items by employing one or more Machine Learning (ML) models (here forth also termed as ML model). The ML model may utilize content metadata 224 and user interaction history data 226 to identify patterns in user behavior and content engagement and identify the contextual meaning and time relevancy of each of the content items. The content metadata 224 may include, but not limited to, timestamps, sender details, and content type of the receive content items. Simultaneously, the user interaction history data 226 may provide insights into frequency of the user 102 engagement with specific types of content, response times, and engagement levels. For example, if the user 102 consistently engages with time-sensitive notifications like reminders or alerts shortly after receipt, the ML model may identify the pattern and associate a higher degree of importance or urgency to similar content items in future interactions, recognizing the temporal context as an indicator of increased relevancy.

In an embodiment, the ML model may analyze historical data 226 related to the content item, including user interactions, engagement metrics, and feedback. By examining the historical data 226, the ML model may identify patterns that indicate a shift of relevancy of content items over time. For instance, certain topics may have been highly relevant in the past but have since declined in interest due to changes in societal trends or user preferences. Further, the ML model may learn from the historical patterns to adjust criteria for relevance accordingly.

In an embodiment, the ML model may analyze the other data 230 may identify patterns in the contextual meaning and time relevancy of the one or more content items that indicate a shift of relevancy of content items over time. The other data may include location data, device data, session data, feedback data, social media data, event data etc.

In an embodiment, the analyzer module 214 may identify the contextual meaning and time relevancy of each of the one or more content items based on user 102 feedback. The user 102 may provide input on the relevance of specific content items. Further, the user input may be integrated into the analysis, to adapt over time. By continuously learning from user interactions and feedback, the analyzer module 214 may enhance the accuracy in identifying contextual meaning.

In an embodiment, the analyzer module 214 may analyze the content items, in the machine-readable format, to identify contextual meaning and time relevancy of each of the content items. The analyzer module 214 may use a Machine Learning (ML) model that is trained to determine time relevancy and time irrelevancy of different content items based on associated semantic. The ML model may use any or combination of a regression model, a self-learning model, a self-adapting model, and a self-improving model, to determine the time-relevancy of each of the content items. The analyzer module 214 may determine the time relevancy of each content items based on timestamp of each received content items, semantic of each content items, contextual correlation of each of the content items with its preceding or subsequent content items of similar type, publicly available data, and personal data of the user.

In an embodiment, the ML model may incorporate real-time data, to identify contextual meaning and time relevancy of each of the one or more content items. The real-time data may be varied in type, including, but not limited to, current events, social media trends, or other dynamic sources of information that reflect the ever-changing landscape of user interests. Further, the ML model may integrate the real-time data streams, to ensure that assessments remain timely and contextually appropriate. For example, if a particular subject suddenly gains attention in the news, the ML model may recognize the shift and prioritize related messages for the user 102.

In an embodiment, the one or more ML models may include Natural Language Processor (NLP), Artificial Intelligence (AI) regression model, self-learning model, self-adapting model, and self-improving model. Further, the one or more ML models may determine time-relevancy or time relevancy of each of the one or more content items (here forth also termed as content items) based on a subsequent content item, publicly available data, and personal data of the user.

In an embodiment, the one or more machine learning models may analyze the characteristics, time relevancy, and context of the subsequent content item, to identify patterns or changes that may affect the relevance of earlier content. The identified pattern or change may help assess the ML model shifts in relevance based on changing contexts or emerging trends. Further, the identified pattern or change may help the ML models understand impact of the new information on the existing content item. Additionally, the ML models may dynamically adjust the time-relevancy of content items, ensuring that users receive the most pertinent and timely information aligned with their interests and needs.

In an embodiment, the content of the preceding and subsequent message may be useful in determining the time relevance as the preceding and subsequent messages may provide information about whether the problem or requirement in the message has been solved or not. For example, if a message is associated with a request by a first user for a ladder to repair light, and the subsequent messages include a second user providing a ladder and the first user thanking him, then the messages may not be relevant for the user at the time of reading the message. In another example, if a message is associated with a request by a first user to bring a football for the picnic tomorrow, and the subsequent message includes a second user saying he has packed the football, then even though the messages seem relevant because of an upcoming event but are not relevant because the task has already been fulfilled at the time of reading the message. In yet another example, if a message is associated with a ride-sharing option for the next week and the subsequent messages suggest the seat vacancy being filed. In such cases, although the message may be significant and time-relevant in terms of the upcoming week, at the time of reading the message, the message may lose the significance of being relevant as the seat vacancy is fulfilled. The analyzer module 214 may mark such content items as contextually irrelevant.

In an embodiment, publicly available data may include, but is not limited to, trending topics, news events, and social media activity. The publicly available data 226 may be utilized by the ML model to understand the broader landscape in which the user 102 may operate. the models can identify patterns and emerging trends relevant to interests of the user 102. The ML model may analyze public data 228 from various public sources to detect shifts in public sentiment, changes in popular topics, trends, and significant events that may influence user engagement. Further, the ML models may prioritize content that may align with the identified patterns and emerging interests. For example, if a major news event occurs that aligns with the content item the user 102 receives, the ML model may elevate the relevance of that content item. The elevation may occur due to the contextual importance of the event, which also aligns with the timing of the content items reception.

In an embodiment, the content item may include information or news that was true but is old and may not be true or relevant now, in such cases publicly available data such as general articles or news may be very helpful in determining whether the message is time-relevant as well as contextually relevant to the user. For example, a first user shares a forward message to a second user stating ‘do not travel via ring road today because PM is visiting’. However, at the time the second user reads the forwarded message, the publicly available data may indicate that PM visited a month ago and there is no visit scheduled today. Thus, the forwarded messages would have been 1 month old and the message is time-irrelevant now for the user. In another similar example, a first user shares a forward message to a second user stating ‘do not travel via ring road today because PM is visiting’. However, at the time the second user reads the forwarded, the publicly available data may indicate that PM visit was cancelled 3 days ago. By correlating the forwarded messages with publicly available data, the system 108 may conclude that the ring road would not be blocked today and the message is time-irrelevant now for the user. In yet another similar example, a first user shares a forward message stating ‘do not travel via ring road today because PM is visiting’. However, at the time of reading the message, the publicly available data says that PM visited 3 hours ago. By correlating these content items with publicly available data, the system 108 may conclude that the ring road would not be blocked now and the message is time-irrelevant now for the second user. In such scenarios, the system 108 will mark the content item stating “do not travel via ring road today because PM is visiting’ as time irrelevant.

In an embodiment, the personal data of the user (such as user schedule, user route, user likes/dislikes, or the like) plays an important part in determining the time relevancy of the messages. For example, a received message states that the road to electronic city is closed and is diverted through Highway-4 from 1 Jan. 2023 to 1 Sep. 2023. Considering the user's office was in electronic city till 1 Mar. 2023 and later shifted to Silicon City which is opposite Electronic City and is not affected by the road to Electronic City. Thus, if the user views the message before 1 Mar. 2023, then the message may be time-relevant but if the user views the messages after 1 Mar. 2023, then the message may be time-irrelevant.

In an embodiment, the personal data of the user 102 may include historical interactions, preferences, and behavior of the user 102 with similar content over time. Further, based on the personal data, the ML model may create a profile that may reflect unique tendencies of the user 102. Furthermore, based on the personal data, the ML model may assess the time-relevance of content items more accurately. For example, if the user 102 regularly engages with time-sensitive offers or reminders about upcoming appointments, the ML model may weigh similar content items more heavily in relevance assessment. Based on the analysis of the user 102 past interactions, the ML models may create a detailed profile that may reflect the user 102 preferences and typical behaviors when engaging with content over time. In an embodiment, the ML model may dynamically update the user 102 profile based on recent interactions, adapting to any changes in behavior or preferences. The dynamic updating may facilitate the analyzer module 214 to identify time-relevant content, reflecting both immediate user needs and long-term tendencies.

In an embodiment, the NLP may analyze text from various content items, such as emails and messages, to extract meaning and significance. The NLP may process syntactic structure of sentences and identify keywords, phrases, and sentiments that indicate urgency or relevance. For example, an email containing phrases like “urgent,” “deadline,” or “immediate action required” would be flagged as time-relevant due to the NLP's understanding of contextual language cues.

In an embodiment, the AI regression model may utilize historical data and patterns to assess the likelihood of the content item being time-relevant. For instance, if a user has previously engaged with similar content during specific times, the regression model may predict that new content of a similar nature may also be relevant. For example, if a message mentions ‘today’ and the user current reading time is a day after that, then the message may not be relevant anymore.

In an embodiment, the self-learning models may improve over time based on user interactions and feedback. The analyzer module 214 may utilize self-learning capabilities to adapt to the user 102 evolving preferences and behavior. As the user 102 engages with various content items, the self-learning model may learn from the behavior and refine criteria to determine relevance. For example, if a user increasingly engages with time-sensitive travel alerts, the self-learning model may become more attuned to identifying and prioritizing similar alerts in the future. Further, the self-adapting models may dynamically adjust parameters based on real-time data inputs. Furthermore, the self-learning model may consider variables such as changing user preferences, seasonal trends, or even contextual factors like the time of day. For instance, if a user is typically more responsive to work-related content during weekdays, the self-adapting model may prioritize such content more heavily during these periods, ensuring that the user receives the most pertinent information at the right time.

In an embodiment, the self-improving model may utilize feedback loops to enhance performance. Further, the self-improving model may collect data on user interactions with various content items, including metrics such as click-through rates, time spent engaging with content items, and the subsequent actions taken by the user 102 after receiving certain content items. For instance, if a user frequently interacts with time-sensitive notifications, the self-improving model may identify a pattern and consider the interaction a significant indicator of content relevance. By incorporating such data, the self-improving model may identify the types of content that resonate with the user 102, leading to improved predictions regarding future content relevancy.

Refining algorithms may be a vital aspect of the self-improving model. The algorithms may start with predefined rules based on initial training data, but as the self-learning model encounters new data, the model may adjust parameters to enhance accuracy. Adjusting parameters may include recalibrating weights assigned to various features used in the relevance determination process. For example, if a particular sentiment score becomes more predictive of user engagement over time, the model may increase the importance of that feature during analysis.

In an embodiment, the analyzer module 214 may align accurately with the user 102 needs based on a continuous influx of new information, ensuring that the content relevancy assessments become more relevant. Further, analyzer model may be communicatively coupled to the database 110 for determining time-relevancy of each of the received one or more messages for the user 102.

In an embodiment, the analyzer module 214 may analyze the one or more content items, in the machine-readable format to mark each of the one or more content items as time-relevant or time-irrelevant. The marking of each of the one or more content items as time-relevant or time-irrelevant may be based on the identified corresponding contextual meaning and time relevancy. The analyzer module 214 may utilize the identified corresponding contextual meaning and time relevancy to apply predefined criteria that may reflect contemporary trends, user interests, and external factors. Further, the analyzer module 214 may ensure that the marking process reflects the evolving nature of content relevance.

In an embodiment, the marking of content items may be time-relevant or time-irrelevant based on the identified contextual meaning and/or time relevancy. The analyzer may evaluate each content item against specific criteria that may reflect current trends, user preferences, and situational factors. For example, if a content item relates to an ongoing event or a subject that is gaining attention, the content item will be classified as time-relevant. The marking and/or classification may ensure that user 102 may focus on the content items that resonate with immediate interests. Alternatively, content items deemed outdated or no longer significant may be marked as time-irrelevant. Further, the marking and/or classification may facilitate filtering out less relevant information.

In an embodiment, the presentation module 216 may render the one or more content items to the user 102 with corresponding time-relevant and time-irrelevant tags based on the marking. Further, the presentation module 216 may present the user 102 with an option to view each of the one or more content items with time-relevant and/or time-irrelevant tags, and only the one or more content items marked as time-relevant.

In an embodiment, the presentation module 216 may display and/or visualize the tagged content items, via user device 104, including both time-relevant and time-irrelevant tags alongside each content item. The tagged visual representation may facilitate the user 102 to quickly discern the content items currently pertinent. Further, the tagging may improve the user experience by empowering the user 102 to make informed decisions about what to engage with. For instance, a user may notice a time-relevant tag on an article discussing an ongoing event, prompting immediate interest and interaction with the article.

In an embodiment, the presentation module 216 may provide the user with customizable viewing options. One option may facilitate the user 102 to view all available content items, complete with the associated time-relevant and time-irrelevant tags. The customizable may enable the user 102 to explore a broader range of information, which may include content items that, although not immediately relevant, still offer valuable insights or connections to other interests.

In an embodiment, the presentation module 216 may include interactive elements associated with the tags. For instance, the user 102 may interact with a tag to view all content items associated with that particular relevance classification. In an embodiment, the presentation module 216 may to adapt based on user behavior. For example, if a user frequently interacts with time-relevant content, the presentation module may prioritize the display of such items in future sessions, enhancing the personalization of the user experience.

In an embodiment, the filtering module 218 may filter out the one or more content items marked as time-irrelevant, such that only time-relevant content items are rendered to the user. Further, the filtering module 218 may review the tags/classifications, to identify and exclude any content items that may have been designated as time-irrelevant. The selective filtering may enhance the quality of information presented to the user 102, and facilitate engagement with content items having immediate interests and needs. The user 102 may quickly access timely information without sifting through outdated or less significant content items.

In an embodiment, the filtering module 218 may facilitate the user 102 to customize filtering preferences, such as specifying particular topics of interest or adjusting the timeframe for what they consider relevant. Further, the filtering module 218 may utilize real-time data inputs to dynamically adapt filtering criteria. Furthermore, the filtering module 218 may, based on trending topics or current events, adjust filtering to prioritize content that may align with emerging interests or user behavior patterns.

In an embodiment, the ranking module 220 may rank the one or more filtered time-relevant content items such that the ranked one or more filtered time-relevant content items are rendered to the user 102. Further, the ranking module 220 may rank the one or more filtered time-relevant content items based on urgency associated with the one or more content, time-sensitivity decay rate, user historical engagement levels with related time-relevant content, and proximity of the time-relevant content to a scheduled event. Further, the ranking module 220 may ensure that the most time-sensitive information remains easy to find, and outdated messages don't dominate the conversation.

In an embodiment, the urgency associated with the one or more content items may include importance and/or criticality of the content item in relation to the user 102 current context. For example, content items marked as urgent may require immediate attention or action from the user 102. Further, the urgency may be determined by the nature of the content, such as whether the content item contains high-priority information that may directly impact the user 102 decision-making or situational awareness. For example, a user is subscribed to notifications from a news app. If there is an urgent breaking news story, such as a natural disaster or a political event, that content may be ranked higher due to immediate importance. The ranking module 220 may identify the urgency and push the content item to the top of the user 102 feed, ensuring timely access to crucial information. Meanwhile, less urgent news, like a report on long-term economic trends, may be ranked lower, reflecting lesser immediacy.

In an embodiment, the time-sensitivity decay rate may indicate the speed at which the relevance of the content item diminishes over time. Certain content items may have a limited window during which the information of the content item may be useful or meaningful to the user 102. The ranking module may ensure that content items with fast-decaying time sensitivity may be prioritized for immediate presenting, preventing outdated or expired information from being presented to the user 102. For example, in a family group chat, if a family member shares a message about dinner plans for the evening, the shared message may be highly relevant before dinner. The ranking module 220 may prioritize the message so everyone in the group may see the message. However, once dinner time has passed a threshold time, the relevance of the message drops quickly allowing more current content items to take precedence.

In an embodiment, while the threshold time may indicate a shift in relevance, the dinner message may be retained within the relevant tag for a brief period. The user 102 may still find value in reflecting on past events or discussions shortly after occurrence. Even after dinner has passed, the family members may want to share memories, photos, or comments related to the meal. The retention may allow for continuity in conversation and engagement among family members, ensuring that the chat remains lively and connected even as the focus shifts to newer content.

In an embodiment, the user 102 historical engagement levels with related time-relevant content may include the user 102 past interactions with similar content. The ranking module 220 may assess the frequency at which the user engages with particular types of content and use the data to rank new content items that may align with historical preferences. The ranking may ensure that content deemed more interesting or relevant to the user 102, based on previous behavior, is ranked higher.

In an embodiment, the proximity of the time-relevant content to a scheduled event may refer to a closeness of the content item to the scheduled event that may be approaching or has just occurred. Further, the content items that may be directly tied to an upcoming event or activity may be ranked higher and become more relevant in the context of the event timeline. For example, if a housing community chat group has a message about an upcoming neighborhood cleanup scheduled for Saturday, the ranking module 220 may elevate the ranking of the message as the event date approaches. As the cleanup day gets closer, related content items, such as reminders, supply lists, or volunteer sign-up links may even be ranked higher. Additionally, if the cleanup has just occurred, related content such as thank-you messages, feedback surveys, or photos from the event may also be prioritized, for a threshold period of time, to keep the conversation relevant. The ranking based on the proximity of the time-relevant content may ensure that user 102 may receive timely information on the most relevant events.

In an embodiment, the other modules 222 may include a range of additional modules to enhance system 108 functionality. The other modules 222 may facilitate improving data management, enabling efficient storage and retrieval of information while ensuring security. Further, the other modules 222 may also facilitate the seamless integration of user feedback, allowing the system 108 to adapt based on real-time insights to boost user satisfaction.

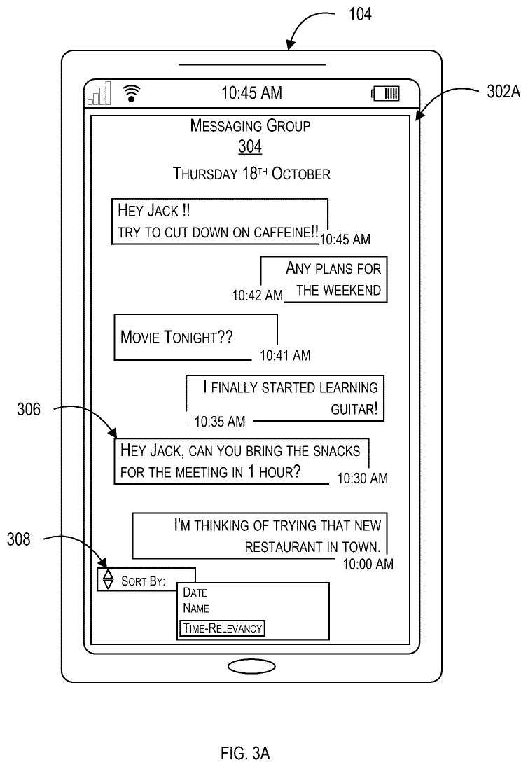

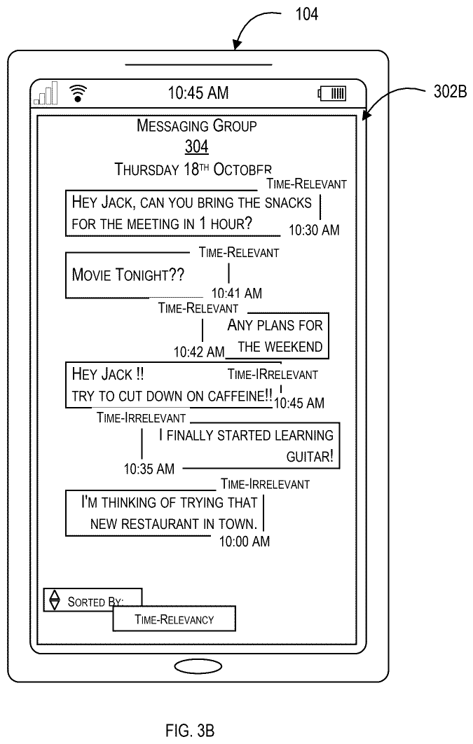

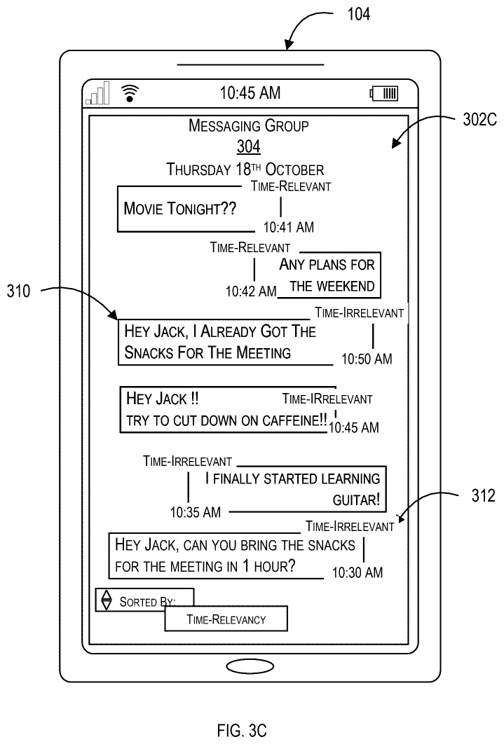

FIG. 3A illustrates an exemplary user interface 302A displaying messages received at various time instances in a messaging group 304 on the user device 104 that is further presented in an optimized manner in accordance with an embodiment of the present disclosure. FIG. 3B illustrates an exemplary user interface 302B displaying messages prioritized based on time relevancy, in accordance with an embodiment of the present disclosure. FIG. 3C illustrates an exemplary interface 302C displaying relevancy adjustment of time-relevant message, in accordance with an embodiment of the present disclosure. For the sake of brevity FIG. 3A, FIG. 3B, and FIG. 3C are explained together.

In an embodiment, the user device 104 may be associated with the user 102. The user 102, who may be named Jack, may be a member of the messaging group 304. Further Jack may receive a time-relevant message (also termed as initial message) such as “Hey Jack, can you bring the snacks for the meeting in 1 hour?” as shown by 306. However, the time-relevant message may be displayed after some time-irrelevant messages because newer messages arriving later are displayed at the top of the interface 302A. As the time-relevant message is displayed after less relevant messages, may result in a delay in visibility. Since newer messages are displayed above older ones, the time-relevant message may not be immediately visible to Jack, potentially leading to missed or overlooked critical information. Additionally, a reduced immediate impact of the time-sensitive message might be experienced. If the message is located beneath less relevant content, the urgency of requests or alerts may be diminished, leading to potential delays in response. For instance, a request to “Bring the snacks in 1 hour”may not prompt timely action if it is not prominently displayed.

In an embodiment, such a display of messages may decrease efficiency, as Jack's ability to respond swiftly to important messages may be compromised, resulting in missed opportunities or deadlines. Furthermore, user experience might suffer, as Jack may become frustrated or confused while searching through less relevant content for crucial, time-sensitive information. Accordingly, the user 102 (Jack) may select an option to sort by time relevancy using the sort option, as shown by reference 308. The user 102 may access the sort option and choose to sort the message based on time relevance, allowing prioritization and visibility of messages as illustrated in FIG. 3B, via user interface 302B. The sorting option may facilitate displaying important, time-sensitive messages prominently, enhancing overall efficiency and ensuring prompt access to critical information. Further, all messages in the chat may be tagged as either time-relevant or time-irrelevant, allowing for seamless categorization and filtering within the messaging group.

In an embodiment, the system may identify subsequent content items to the initial message “Hey Jack, can you bring the snacks for the meeting in 1 hour?” that may be contextually relevant and time-sensitive. The identified subsequent content items may include a response and/or update from another member of the group, such as “Hey Jack I already got the snacks for the meeting”, as shown via 310, in the user interface 302C. Based on the identified subsequent content items that system 108 may determine the contextual relevancy and time-sensitiveness to the initial message, “Hey Jack, can you bring the snacks for the meeting in 1 hour?”. Further, the system 108 may determine that the initial message no longer may hold any time sensitivities. Furthermore, the system 108 may identify the decrease in relevancy of the initial message, and may adjust the tagging of the initial message to time-irrelevant, as shown by 312. The dynamic tagging adjustment may ensure that the user 102 (Jack) receives the most current and relevant information, and may reflect the latest updates and changes in the context of ongoing conversations.

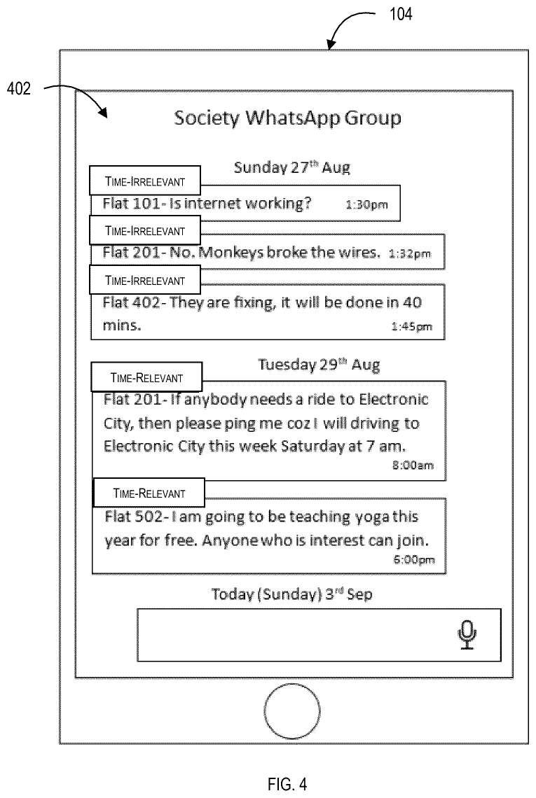

FIG. 4 illustrates an exemplary user interface 402 of the user device 104 displaying messages marked based on time relevancy, in accordance with an embodiment of the present disclosure. In an embodiment, the user 102 may view the messages 404, 406, 408, 410, and 412, on the user interface 402, on Friday of the same week i.e. 1st of September. The messages shown by 404, 406, and 408 may no longer be relevant. The discussion/context/matter within the messages 404, 406, and 408 may have concluded on Sunday, August 27th, making them irrelevant to the user 102 on Friday. Accordingly, the system 108 may tag messages shown by 404, 406, and 408 as irrelevant. Conversely, the messages indicated by 410 and 412 may still be tagged as relevant, as the discussion/context/matter of the message may pertain to upcoming events or deadlines in the following days.

In an embodiment, the user 102 may view the messages, 404, 406, 408, 410, 412, on the user interface 402, on Saturday evening, the system 108 may update the relevancy tags based on the evolving context. The messages shown by 404, 406, 408, and 410 may now be marked as time-irrelevant, as the associated context has passed. Only the message indicated by 420 may remain time-relevant, as the associated context or matter has a later completion date. Accordingly, the system 108 may automatically tag messages 404, 406, 408, and 410 as time-irrelevant, and similarly, the message indicated by 412 may be tagged as time-irrelevant.

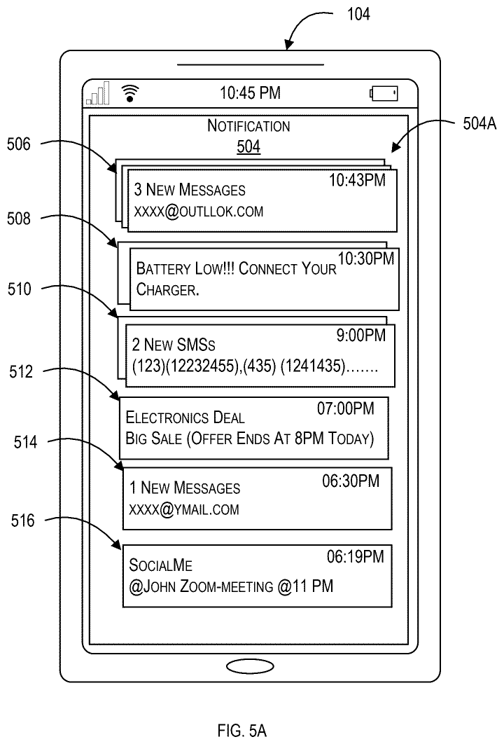

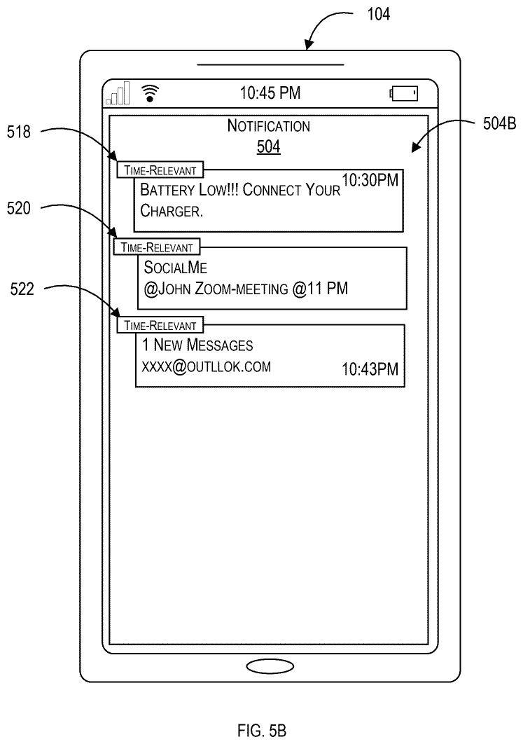

FIG. 5A illustrates a user interface 502A displaying various notifications received at different time instances that are presented in an optimized manner on the user device 104 in accordance with an embodiment of the present disclosure. FIG. 5B illustrates a user interface 502B displaying only the notifications with time-relevant tag, on the user device 104 in accordance with an embodiment of the present disclosure. For the sake of brevity, FIG. 5A and FIG. 5B are explained together.

In an embodiment, the user 102 may receive notifications 504 on the user device 104. The notification may include system notifications and messages from various digital platforms received at different time instances. Further, the notifications 504 may be grouped together based on predefined criteria, such as subject matter or source, as shown by the user interface 502A. The grouping of notifications may lead to certain challenges for the user 102. When multiple notifications are grouped together, especially those that are time-sensitive, the user 102 may not be able to discern the notifications that are of immediate relevance. The lack of clarity may cause confusion, leading the user 102 to potentially discard or overlook important notifications without reviewing properly. For example, critical system alerts or urgent messages may be grouped with less important updates, reducing their visibility and importance.

In an embodiment, the system 108 may analyze all incoming notifications and messages, including both individual and grouped ones, to determine relevancy. Further, the system 108 may utilize uses machine learning models to evaluate each notification and message for time relevancy. The evaluation may include analyzing and checking the content of the messages, the context of the messages, and determining whether the message requires immediate attention. For example, the grouped system notification, as shown by 508, may include a critical message of urgent attention. The system may analyze the grouped notification such as the email grouping shown by 506, system notification 508, and sms grouping as shown by 510, to identify time-relevant notification within the group message. Upon, such identification of time-relevant notification, the system 108 may tag the identified notification as time-relevant. Similarly, the system 108 may analyze individual messages such as advertisements as shown by 512, other emails as shown by 514, and social media messages as shown by 516, to determine time-relevancy and accordingly tag the corresponding notifications. Further, the system 108, after the identification and tagging of the time-relevant notifications, may only render and/or display such time-relevant notifications, as shown by the user interface 502B.

In an embodiment, the system 108 may only display the content items tagged as time-relevant, as shown in FIG. 2, and may not display any time-irrelevant messages so that the user can only focus on the time-sensitive matters and may discard non-time-sensitive notifications.

In an embodiment, the system 108 may identify a message such as “Battery Low!!! Connect Your Charger.” received at 10:30 PM, as time-sensitive as the notification requires immediate user action to prevent the device from shutting down. Further, the system 108 may flag the notification as a priority and may display the notification with the time-relevant tag, shown by 518. Furthermore, the system 108 may identify that the individual notifications “ZOOM-MEETING @11 PM”, as shown by 516 may also be tagged as time-relevant as the notifications 520 may contain urgent information. Moreover, the system 108 may have also identified an email notification, from the grouped email 506, that may have time constraints. Furthermore, the system 108 may tag and display such notification as time-relevant, as shown by 522.

In an embodiment, the system 108 may identify older notifications or messages about past events, such as outdated sales or completed meetings, and mark such notifications as irrelevant. Notification like “BIG SALE (OFFER ENDS TODAY 8 PM today)”, shown by 512, although highly relevant at the time of receiving i.e. at 7:00 PM may lose relevancy depending on the current timing i.e. 10:45 PM. The system 108 may identify that such notification may not cause any significant impact on the user at the current time and may not display the notification once impact time elapses.

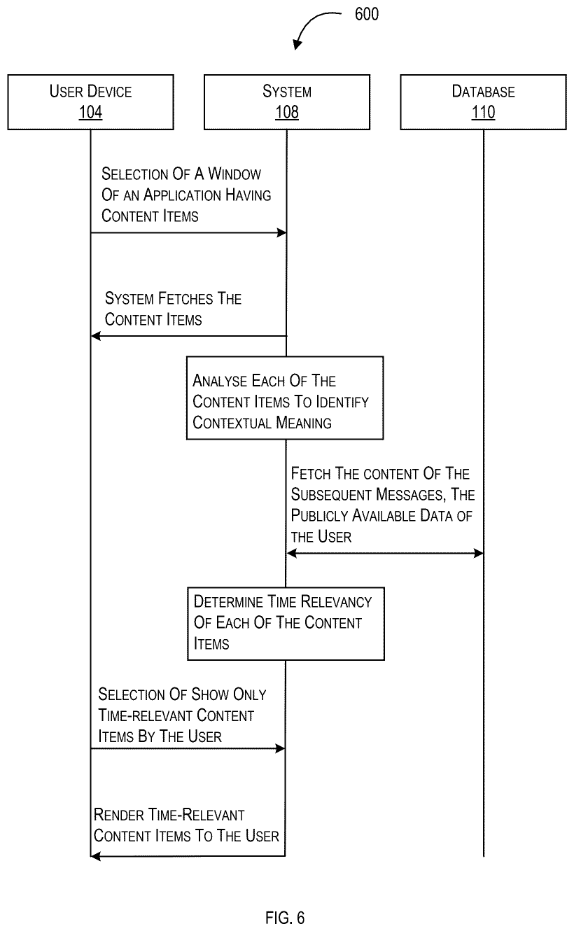

FIG. 6 illustrates a timing diagram 600 for presenting time-relevant content items to the user 102, in accordance with an embodiment of the present disclosure. In an embodiment, the system 108 may operate to ensure that time-relevant content is effectively presented to the user 102 through a seamless interaction between the user device 104, the system 108, and the database. 110 The process may begin when the user 102 opens the applications, such as a messaging or social media platform. The system 108 may retrieve all available messages or notifications from various platforms to ensure that the user may be presented with the most up-to-date content.

In an embodiment, once the content items are received, and displayed on the user interface of the user device 104, the messages may appear unfiltered without any indication of time relevance. The user 102 may see all content regardless of any immediate importance. The unfiltered display may facilitate the user 102 to interact freely with the messages, offering an intuitive experience similar to what they are accustomed to on their preferred platforms.

In an embodiment, the system 108 may perform analysis and examine each message for time-sensitive details, such as event dates, deadlines, or temporal references like “today” or “tomorrow.” Further, the system 108 may evaluate the content in real time to identify messages that may be relevant based on the current time. Furthermore, the system 108 may access the data available in the database 110, to determine content relevance and time relevancy. In an embodiment, the analysis and examination may occur without requiring any input from the user 102.

In an embodiment, the database 110 may store two types of data: public and personal. The public data may include information such as news articles or public announcements, facilitating the system 108 to verify status of the events mentioned in messages. The personal data may relate to the user's schedule, preferences, or previous interactions.

In an embodiment, the system 108, based on analysis and examination, may assign time-relevance tags to each message. The messages still having importance or time may be tagged as “time-relevant,” while the messages that no longer hold significance may be labeled as “time-irrelevant.” The tagging may be crucial for helping the user 102 prioritize the content.

In an embodiment, after the messages have been tagged, the user interface of the user device 102 may update to reflect the tags. Time-relevant messages may be visually highlighted, perhaps through color-coding, with green indicating messages that are still relevant and red for the irrelevant messages. Alternatively, the time-relevant messages may be given star ratings, with five stars for the most relevant messages and one star for the least relevant messages. The update may facilitate the user 102 to quickly assess the messages that may require immediate attention, without needing to sift through outdated or irrelevant content manually.

In an embodiment, the user 102 may choose to view only the time-relevant messages, using a filter option that may hide time-irrelevant content. Alternatively, the user may opt to view all messages with the respective tags, providing flexibility based on preferences and needs at the moment.

In an embodiment, as time progresses, the system 108 may continue to monitor the relevance of previously received messages. If a message that was initially time-relevant becomes irrelevant (for instance, an event that has already passed), the system 108 may automatically update the associated status and reflect the change in the user interface of the user device 104. The dynamic process ensures that the user 102 is always presented with the most timely and pertinent information, streamlining their content consumption and improving overall efficiency.

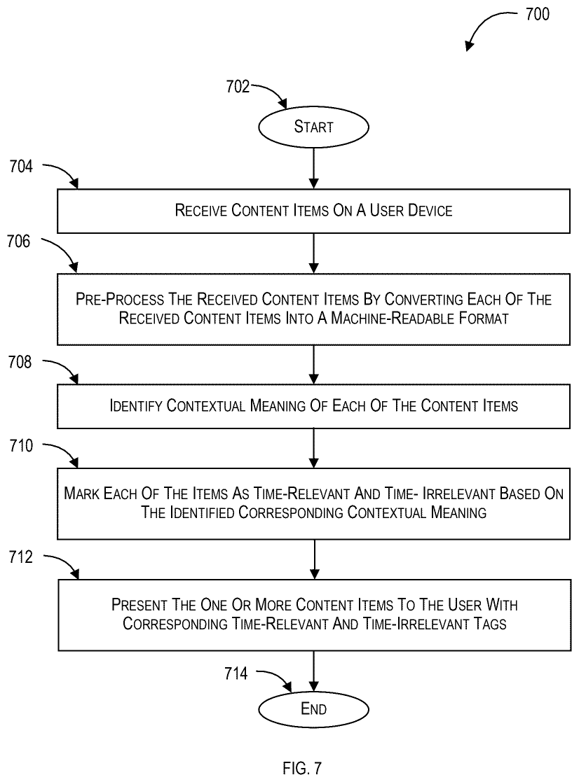

FIG. 7 illustrates an exemplary flowchart 800 for a method for presenting time-relevant content to a user, in accordance with an embodiment of the present disclosure. The method starts at step 802.

At step 804, the method may include receiving one or more content items on a user device. The one or more content items may be received from one or more digital platforms. Further, the one or more content items may include system notifications, emails, text messages, Short Message Service (SMS), image messages, video messages, audio messages, and social media alerts. Furthermore, the one or more content may be associated with traditional messages, Multi-Media Services (MMS), WhatsApp, Facebook posts, Facebook Messenger, Instagram, Slack, Twitter, or the any other social media/communication service. In an embodiment, the one or more digital platforms may include pre-installed applications, third-party applications, and system applications.

At step 806, the method may include step of pre-processing the received one or more content items by converting each of the received one or more content items into a machine-readable format. During pre-processing, the method may use a speech-to-text engine, a Natural Language Processor (NLP), and an image-to-text engine. The speech-to-text engine may convert the received audio messages into text. Further, speech-to-text engine may convert the speech into exact text with low accuracy due to reasons such as, but not limited to, accents. The natural languages Processor (NLP) processes may convert text by the speech-to-text engine into text messages.

At step 808, the method may include step of analyzing the one or more content items, in the machine-readable format, to identify contextual meaning and time relevancy of each of the one or more content items by employing one or more Machine Learning (ML) models. The one or more ML models may include Natural Language Processor (NLP), Artificial Intelligence (AI) regression model, self-learning model, self-adapting model, and self-improving model. Further, the one or more ML models may determine time-relevancy of each of the one or more content items based on a subsequent content item, publicly available data, and personal data of the user.

At step 810, the method may include step of analyzing the one or more content items, in the machine-readable format, to mark each of the one or more content items as time-relevant and time-irrelevant based on the identified corresponding contextual meaning and time relevancy. Further, marking may include utilizing the identified corresponding contextual meaning and time relevancy to apply predefined criteria that may reflect contemporary trends, user interests, and external factors.

At step 812, the method may include step of presenting the one or more content items to the user with corresponding time-relevant and time-irrelevant tags based on the marking. Further, the presenting may include providing the user with an option to view each of the one or more content items with time-relevant and/or time-irrelevant tags, and only the one or more content items marked as time-relevant. Furthermore, the presenting module may include displaying and/or visualizing the tagged content items, including both time-relevant and time-irrelevant tags alongside each content item.

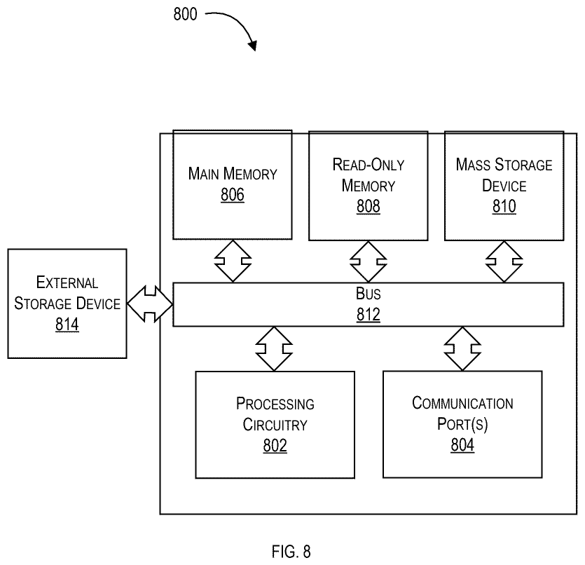

FIG. 8 is an exemplary computer unit 800 in which or with which embodiments of the present disclosure may be utilized. Depending upon the implementation, the various process and decision blocks described above may be performed by hardware components, embodied in machine-executable instructions, which may be used to cause a general-purpose or special-purpose processor programmed with the instructions to perform the steps, or the steps may be performed by a combination of hardware, software and/or firmware. As shown in FIG. 7, the computer system 800 includes an external storage device 814, a bus 812, a main memory 806, a read-only memory 808, a mass storage device 810, a communication port(s) 804, and a processing circuitry 802.

The computer system 800 may include more than one processing circuitry 802 and one or more communication ports 804. The processing circuitry 802 should be understood to mean circuitry based on one or more microprocessors, microcontrollers, digital signal processors, programmable logic devices, Field-Programmable Gate Arrays (FPGAs), Application-Specific Integrated Circuits (ASICs), etc., and may include a multi-core processor (e.g., dual-core, quad-core, Hexa-core, or any suitable number of cores) or supercomputer. In some embodiments, the processing circuitry 802 is distributed across multiple separate processors or processing units, for example, multiple of the same type of processing units (e.g., two Intel Core i7 processors) or multiple different processors (e.g., an Intel Core i5 processor and an Intel Core i7 processor). Examples of the processing circuitry 802 include, but are not limited to, an Intel® Itanium® or Itanium 2 processor(s), AMD® Opteron® or Athlon MP® processor(s), Motorola® lines of processors, System on Chip (SoC) processors, or other future processors. The processing circuitry 802 may include various modules associated with embodiments of the present disclosure.

The communication port 804 may include a cable modem, Integrated Services Digital Network (ISDN) modem, a Digital Subscriber Line (DSL) modem, a telephone modem, an Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of electronic devices or communication of electronic devices in locations remote from each other. The communication port 804 may be any RS-232 port for use with a modem-based dialup connection, a 10/100 Ethernet port, a Gigabit, or a 10 Gigabit port using copper or fiber, a serial port, a parallel port, or other existing or future ports. The communication port 804 may be chosen depending on a network, such as a Local Area Network (LAN), Wide Area Network (WAN), or any network to which the computer system 800 may be connected.

The main memory 806 may include Random Access Memory (RAM) or any other dynamic storage device commonly known in the art. Read-only memory (ROM) 808 may be any static storage device(s), e.g., but not limited to, a Programmable Read-Only Memory (PROM) chips for storing static information, e.g., start-up or BIOS instructions for the processing circuitry 802.

The mass storage device 810 may be an electronic storage device. As referred to herein, the phrase “electronic storage device” or “storage device” should be understood to mean any device for storing electronic data, computer software, or firmware, such as random-access memory, read-only memory, hard drives, optical drives, Digital Video Disc (DVD) recorders, Compact Disc (CD) recorders, BLU-RAY disc (BD) recorders, BLU-RAY 3D disc recorders, Digital Video Recorders (DVRs, sometimes called a personal video recorder or PVRs), solid-state devices, quantum storage devices, gaming consoles, gaming media, or any other suitable fixed or removable storage devices, and/or any combination of the same. Nonvolatile memory may also be used (e.g., to launch a boot-up routine and other instructions). Cloud-based storage may be used to supplement the main memory 806. The mass storage device 810 may be any current or future mass storage solution, which may be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firmware interfaces), e.g., those available from Seagate (e.g., the Seagate Barracuda 7200 family) or Hitachi (e.g., the Hitachi Deskstar 7K1000), one or more optical discs, Redundant Array of Independent Disks (RAID) storage, e.g., an array of disks (e.g., SATA arrays), available from various vendors including Dot Hill Systems Corp., LaCie, Nexsan Technologies, Inc. and Enhance Technology, Inc.

The bus 812 communicatively couples the processing circuitry 802 with the other memory, storage, and communication blocks. The bus 812 may be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects processing circuitry 802 to the software system.

Optionally, operator and administrative interfaces, e.g., a display, keyboard, and a cursor control device, may also be coupled to the bus 812 to support direct operator interaction with the computer system 800. Other operator and administrative interfaces may be provided through network connections connected through the communication port(s) 804. The external storage device 814 may be any kind of external hard drives, floppy drives, IOMEGA® Zip Drive, Compact Disc-Read-Only Memory (CD-ROM), Compact Disc-Re-Writable (CD-RW), Digital Video Disk-Read Only Memory (DVD-ROM). The components described above are meant only to exemplify various possibilities. In no way should the aforementioned exemplary computer system limit the scope of the present disclosure.

The computer system 800 may be accessed through a user interface. The user interface application may be implemented using any suitable architecture. For example, it may be a stand-alone application wholly implemented on the computer system 800. The user interfaces application and/or any instructions for performing any of the embodiments discussed herein may be encoded on computer-readable media. Computer-readable media includes any media capable of storing data. In some embodiments, the user interface application is client-server-based. Data for use by a thick or thin client implemented on an electronic device computer system 800 is retrieved on-demand by issuing requests to a server remote to the computer system 800. For example, computer system 800 may receive inputs from the user via an input interface and transmit those inputs to the remote server for processing and generating the corresponding outputs. The generated output is then transmitted to the computer system 800 for presentation to the user.

The disclosed system and method for analyzing time-relevant messages in a messaging environment (hereinafter referred to as the “disclosed mechanism”) provides numerous advantages over conventional systems, especially in enhancing user communication, improving message prioritization, and increasing the efficiency of time-sensitive interactions. By identifying and tagging messages based on time relevance, the disclosed mechanism ensures that critical, time-sensitive messages are easily accessible and prioritized for the user which minimizes the likelihood of important information being overlooked or delayed.

For instance, messages that require immediate action, such as event reminders or urgent requests, may be tagged as time-relevant, ensuring they are prominently displayed on the user interface. The disclosed mechanism improves communication by facilitating users to prioritize and respond to critical information in a timely manner. Additionally, the ability to automatically deprioritize messages that may have lost relevance reduces clutter in the messaging environment and enables users to focus on important content, enhancing the overall user experience.

The disclosed mechanism further enables dynamic adjustments to message relevancy as the context changes. For example, if a previously time-sensitive message becomes irrelevant due to new information or updates from other users, the disclosed mechanism may automatically reclassify the message as irrelevant ensuring that the most current and important messages remain at the forefront, optimizing the user's ability to manage and respond to ongoing conversations efficiently.

By facilitating the automatic sorting and tagging of messages based on real-time relevance, the disclosed mechanism significantly improves the flow of communication in messaging groups. The disclosed mechanism enhances productivity, reduces response times for urgent matters, and ensures that critical information is always easily accessible, thus contributing to more effective and organized interactions. Overall, the disclosed mechanism optimizes message handling, ensuring efficient prioritization of time-sensitive content, and enhances user engagement.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

I/We claim

1. A system for presenting time-relevant content items to a user, the system comprising:
a receiver module to receive one or more content items on a user device;
a pre-processing module to pre-process the received one or more content items by converting each of the received one or more content items into a machine-readable format;
an analyzer module to analyze the one or more content items, in the machine-readable format, to:
identify contextual meaning and time relevancy of each of the one or more content items by employing one or more Machine Learning (ML) models; and
mark each of the one or more content items as time-relevant or time-irrelevant based on the identified corresponding contextual meaning and time relevancy; and
a presentation module to render the one or more content items to the user with corresponding time-relevant and time-irrelevant tags based on the marking.

2. The system as claimed in claim 1, wherein the one or more content items are received from one or more digital platforms including at least one of: pre-installed applications, third-party applications, and system applications, further wherein the one or more content items include at least one of: system notifications, emails, text messages, Short Message Service (SMS), image messages, video messages, audio messages and social media alerts.

3. The system as claimed in claim 1, wherein the pre-processing module includes at least one of: a speech-to-text engine, a Natural Language Processor (NLP), and an image-to-text engine.

4. The system as claimed in claim 1, wherein the one or more ML models include at least one of: Natural Language Processor (NLP), Artificial Intelligence (AI) regression model, self-learning model, self-adapting model, and self-improving model, to determine time-relevancy of each of the one or more content items based at least on one of: subsequent content item, publicly available data, and personal data of the user.

5. The system as claimed in claim 1, further comprises a filtering module to filter out the one or more content items marked as time-irrelevant, such that only time-relevant content items are rendered to the user.

6. The system as claimed in claim 1, further comprises a ranking module to rank the one or more filtered time-relevant content items, based on at least one of: urgency associated with the one or more content, time-sensitivity decay rate, user historical engagement levels with related time-relevant content, and proximity of the time-relevant content to a scheduled event, such that the ranked one or more filtered time-relevant content items are rendered to the user.

7. The system as claimed in claim 1, wherein the presenting module further provides the user with an option to view at least one of: each of the one or more content items with time-relevant and time-irrelevant tags, and only the one or more content items marked as time-relevant.

8. A method for presenting time-relevant content items to a user, the method comprising:
receiving one or more content items on a user device;
pre-processing the received one or more content items by converting each of the received one or more content items into a machine-readable format;
analyzing the one or more content items, in the machine-readable format, to:
identifying contextual meaning and time relevancy of each of the one or more content items by employing one or more Machine Learning (ML) models; and
marking each of the one or more content items as time-relevant and time-irrelevant based on the identified corresponding contextual meaning and time relevancy; and
presenting the one or more content items to the user with corresponding time-relevant and time-irrelevant tags based on the marking.

9. The method as claimed in claim 8, wherein the one or more content items are received from one or more digital platforms including at least one of: pre-installed applications, third-party applications, and system applications, further wherein the one or more content items include at least one of: system notifications, emails, text messages, Short Message Service (SMS), image messages, video messages, audio messages and social media alerts.

10. The method as claimed in claim 8, wherein the pre-processing module includes at least one of: a speech-to-text engine, a Natural Language Processor (NLP), and an image-to-text engine.

11. The method as claimed in claim 8, wherein the one or more ML models include at least one of: Natural Language Processor (NLP), Artificial Intelligence (AI) regression model, self-learning model, self-adapting model, and self-improving model, to determine time-relevancy of each of the one or more content items based at least on one of: subsequent content item, publicly available data, and personal data of the user.

12. The method as claimed in claim 8, further comprises filtering out the one or more content items marked as time-irrelevant, such that only time-relevant content items are rendered to the user.

13. The method as claimed in claim 8, further comprises ranking the one or more filtered time-relevant content items, based on at least one of: urgency associated with the one or more content, time-sensitivity decay rate, user historical engagement levels with related time-relevant content, and proximity of the time-relevant content to a scheduled event, such that the ranked one or more filtered time-relevant content items are rendered to the user.

14. The method as claimed in claim 8, wherein the presenting module further provides the user with an option to view at least one of: each of the one or more content items with time-relevant and time-irrelevant tags, and only the one or more content items marked as time-relevant.

15. A computer program product including at least one non-transitory computer-readable storage medium having computer-executable program code portions stored therein, the computer program product is configured to:
receive one or more content items on a user device;
pre-process the received one or more content items by converting each of the received one or more content items into a machine-readable format;
analyze the one or more content items, in the machine-readable format, to:
identify contextual meaning and time relevancy of each of the one or more content items by employing one or more Machine Learning (ML) models; and
mark each of the one or more content items as time-relevant and time-irrelevant based on the identified corresponding contextual meaning and time relevancy; and
present the one or more content items to the user with corresponding time-relevant and time-irrelevant tags based on the marking.

16. The computer program product as claimed in claim 15, wherein the one or more content items are received from one or more digital platforms including at least one of: pre-installed applications, third-party applications, and system applications, further wherein the one or more content items include at least one of: system notifications, emails, text messages, Short Message Service (SMS), image messages, video messages, audio messages and social media alerts.

17. The computer program product as claimed in claim 15, wherein the pre-process includes at least one of: a speech-to-text engine, a Natural Language Processor (NLP), and an image-to-text engine.

18. The computer program product as claimed in claim 15, wherein the one or more ML models include at least one of: Natural Language Processor (NLP), Artificial Intelligence (AI) regression model, self-learning model, self-adapting model, and self-improving model, to determine time-relevancy of each of the one or more content items based at least on one of: subsequent content item, publicly available data, and personal data of the user.

19. The computer program product as claimed in claim 15,
further configured to filter out the one or more content items marked as time-irrelevant, such that only time-relevant content items are rendered to the user; and
further configured to rank the one or more filtered time-relevant content items, based on at least one of: urgency associated with the one or more content, time-sensitivity decay rate, user historical engagement levels with related time-relevant content, and proximity of the time-relevant content to a scheduled event, such that the ranked one or more filtered time-relevant content items are rendered to the user.

20. The computer program product as claimed in claim 15, wherein the presenting module further provides the user with an option to view at least one of: each of the one or more content items with time-relevant and time-irrelevant tags, and only the one or more content items marked as time-relevant.
